(19) United States
(12) Patent Application Publication
(10) Pub. No.: US 2019/0279229 A1
(43) Pub. Date: Sep. 12, 2019

(54) FLOW LINE OUTPUT DEVICE, FLOW LINE OUTPUT METHOD, AND RECORDING MEDIUM

(71) Applicant: NEC CORPORATION, Tokyo (JP)

(72) Inventor: Kazuyoshi WARITA, Tokyo (JP)

(73) Assignee: NEC CORPORATION, Tokyo (JP)

(21) Appl. No.: 16/345,896

(22) PCT Filed: Oct. 23, 2017
(86) PCT No.: PCT/JP2017/038099

§ 371 Date: Apr. 29, 2019

(30) Foreign Application Priority Data
Oct. 31, 2016 (JP) 2016-213284

(51) Int. Cl. G06Q 30/02; G06Q 30/06

(52) U.S. Cl. CPC G06Q 30/02; G06Q 30/06

(57) ABSTRACT

A flow-line output device according to the present invention includes: a memory; and at least one processor coupled to the memory. The processor performs operations. The operations includes: receiving a condition indicating a route or a plurality of positions; and outputting information indicating a flow line according to the received condition among flow lines of a plurality of targets.

### TECHNICAL FIELD

The present disclosure relates to a flow-line output device and the like.

### BACKGROUND ART

There is a technique of analyzing movement of an object such as a person in a space such as a store and a factory. For example, PTL (Patent Literature) 1 discloses a technique for analyzing behavior of a person, based on a video. Further, PTL 2 discloses a technique for analyzing behavior of a person by using flow line data.

### CITATION LIST

### Patent Literature

[PTL 1] Patent Literature 1: Japanese Unexamined Patent Application Publication No. 2015-114685

[PTL 2] Patent Literature 2: Japanese Unexamined Patent Application Publication No. 2009-048229

### SUMMARY OF INVENTION

### Technical Problem

A flow line generally represents a movement route (trajectory) of an object in a predetermined space. While flow lines may vary from object to object, flow lines may also show a certain tendency in some objects. Beneficial information may be acquired when a flow line showing such a certain tendency and another flow line can be classified. However, classifying flow lines is not easy in the techniques described in PTLs 1 and 2.

An illustrative object of the present disclosure is to provide a technique for facilitating narrowing down a flow line.

### Solution to Problem

One aspect provides a flow-line output device. The flow-line output device includes: reception means for receiving a condition indicating a route or a plurality of positions; and output means for outputting information indicating a flow line according to the received condition among flow lines of a plurality of targets.

Another aspect provides a flow-line output method. The flow-line output method includes: receiving a condition indicating a route or a plurality of positions; and outputting information indicating a flow line according to the received condition among flow lines of a plurality of targets.

Further another aspect provides a non-temporary computer-readable recording medium. The recording medium records a program causing a computer to execute: a process of receiving a condition indicating a route or a plurality of positions; and a process of outputting information indicating a flow line according to the received condition among flow lines of a plurality of targets.

### Advantageous Effects of Invention

The present disclosure facilitates narrowing down a flow line.

### BRIEF DESCRIPTION OF DRAWINGS

FIG. 1 is a block diagram illustrating one example of a configuration of a flow-line output device.

FIG. 2 is a flowchart illustrating one example of a flow-line output method.

FIG. 3A is a block diagram illustrating a first configuration example of a flow-line search system.

FIG. 3B is a block diagram illustrating a second configuration example of the flow-line search system.

FIG. 3C is a block diagram illustrating a third configuration example of the flow-line search system.

FIG. 4 is a flowchart illustrating one example of a flow-line search method.

FIG. 5 is a block diagram illustrating another configuration example of a flow-line search system 500.

FIG. 6 is a diagram exemplifying a floor map.

FIG. 7 is a diagram exemplifying a data structure of flow line data.

FIG. 8A is a diagram illustrating one example of an input screen.

FIG. 8B is a diagram illustrating another example of an input screen.

FIG. 9 is a diagram exemplifying a screen for selecting a method of designating a search condition.

FIG. 10 is a sequence chart illustrating another example of the flow-line search method.

FIG. 11A is a diagram illustrating one example of a screen for displaying a search result of a flow line.

FIG. 11B is a diagram illustrating another example of the screen for displaying the search result of the flow line.

FIG. 12A is a diagram illustrating one example of correction of a position.

FIG. 12B is a diagram illustrating another example of correction of a position.

FIG. 13 is a block diagram illustrating another example of the configuration of the flow-line output device.

FIG. 14 is a block diagram illustrating one example of a hardware configuration of a computer device.

### EXAMPLE EMBODIMENT

### First Example Embodiment

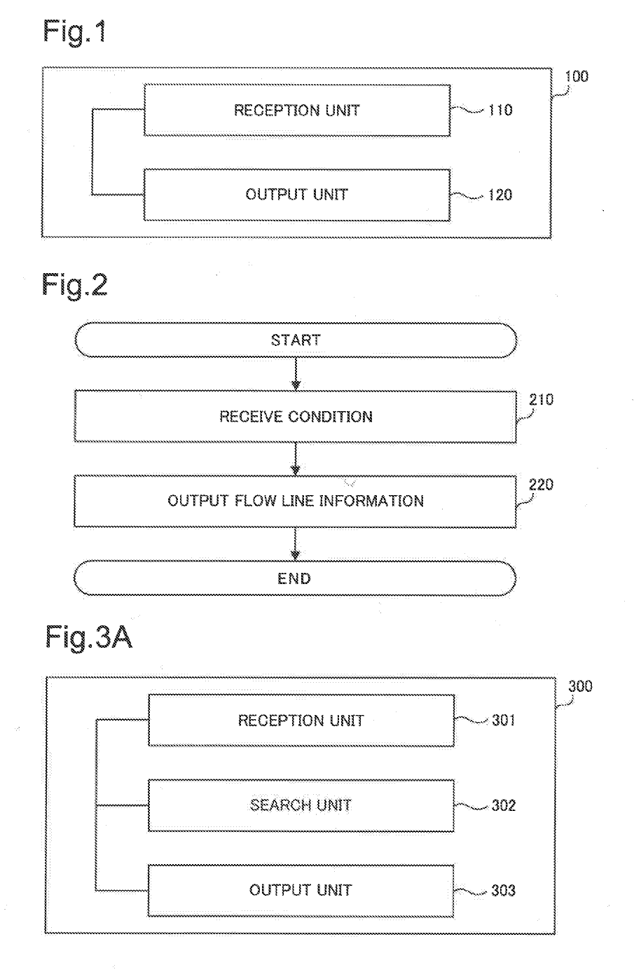

FIG. 1 is a block diagram illustrating a configuration of a flow-line output device 100 according to one example embodiment. The flow-line output device 100 is a device used for searching and outputting a flow line. The flow-line output device 100 is configured to include at least a reception unit 110 and an output unit 120.

The flow line herein represents a movement route (namely, a track or a trajectory) of a target (hereinafter also referred to as a “search target”) recorded in a certain space. The search target is, for example, a human, and may be another movable object. Further, the space herein is a facility and a zone in which a plurality of movable search targets may be present, such as a store or a factory. The flow line is generally one straight line or one curved line from a starting point to an end point. However, the flow line may be partially interrupted and divided into a plurality, and recorded.

In the present example embodiment, a method of recording a flow line is not limited to a specific method. A flow line in the present example embodiment may be recorded by any known recording method. For example, a flow line may be recorded based on a radio wave emitted from equipment attached to an object or equipment (such as a beacon) possessed by a person, or may be recorded by using a sensor or a camera installed in a space in which the flow line is recorded.

The reception unit 110 receives a condition (hereinafter also referred to as a “search condition”) for a flow line to be searched. Specifically, the reception unit 110 detects an operation of designating a position, or receives operation information indicating the operation. In this case, a search condition relates to, for example, operation information indicating an operation by a user who is searched for a flow line. The reception unit 110 can receive a search condition via an input device such as a mouse, or a touch screen display, for example. The reception unit 110 may include such an input device or a touch screen display, but may include only a circuit that detects an operation or a circuit that receives operation information.

The reception unit 110 receives a search condition indicating a route or a plurality of positions. In other words, a search condition received by the reception unit 110 may be a condition that designates a certain position to a different position linearly, or a condition that designates two or more points. A method of designating a search condition is not particularly limited. For example, the reception unit 110 may receive, in a touch screen display displaying an image representing a space in which a flow line is recorded, a search condition by an operation of designating two or more positions included in the image.

The output unit 120 outputs information (hereinafter also referred to as “flow line information”) indicating a flow line. The output unit 120 is, for example, a display device that displays an image according to flow line information. For example, the output unit 120 displays an image for displaying a flow line superimposed on a diagram (such as a sketch and a plan view) representing a space in which the flow line is recorded. Alternatively, the output unit 120 may be an input-output interface for supplying flow line information to a display device (or another device). The output unit 120 outputs flow line information according to a search condition received by the reception unit 110.

Flow line information indicates one or a plurality of flow lines. The flow line information includes, for example, data for displaying a flow line. Specifically, the flow line information may include positional information in which a position of a flow line is described by a predetermined coordinate system. Further, the flow line information may include such positional information and time information indicating time at which the positional information is recorded.

Note that the output unit 120 may output information different from flow line information. For example, the output unit 120 may output, in addition to flow line information, additional information related to the flow line information. The additional information is information indicating an attribute (such as a kind of an object) of a target related to the flow line information, for example.

FIG. 2 is a flowchart illustrating a flow-line output method by the flow-line output device 100. In Step 210, the reception unit 110 receives a search condition that designates a route or a plurality of positions. This search condition is operation information indicating an operation of designating two or more positions included in a space in which a flow line is recorded. The number of positions designated by the search condition in Step 210 may be two or more, and is not limited to a specific number. For example, the search condition in Step 210 may designate a plurality of positions continuously, that is, linearly. Such a search condition relates to a search condition that designates a route.

In Step 220, the output unit 120 outputs flow line information indicating a flow line according to Step 210. Specifically, the output unit 120 outputs flow line information indicating a flow line according to the search condition received in Step 210 among flow lines of a plurality of objects recorded in a predetermined space. For example, the output unit 120 outputs flow line information for displaying a flow line including all positions included in the search condition received in Step 210.

As described above, the flow-line output device 100 in the present example embodiment has a configuration that receive a search condition that designates a plurality of positions, and output flow line information according to the received search condition. This configuration makes it possible to search a flow line by a relatively simple search condition designating a plurality of positions. Therefore, the flow-line output device 100 can make it easy to narrow down a flow line in comparison with a case without such a configuration.

For example, the flow-line output device 100 make it possible to selectively output a flow line of an object passing through two or more specific places in a certain facility according to a search condition among objects moving in the facility. More specifically, the flow-line output device 100 makes it possible to selectively output a flow line of a customer passing through two or more specific selling areas in a certain store among customers visiting the store.

### Second Example Embodiment

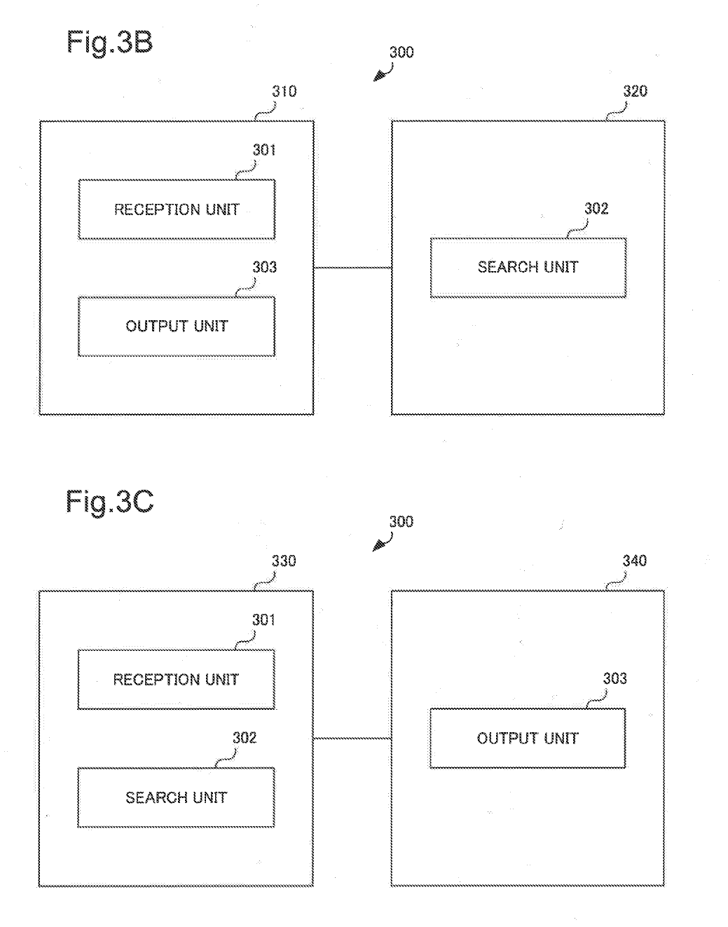

FIGS. 3A, 3B, and 3C are block diagrams illustrating a configuration of a flow-line search system 300 according to another example embodiment. The flow-line search system 300 is configured in such a way as to include a reception unit 301, a search unit 302, and an output unit 303. Note that description overlapping the first example embodiment is appropriately omitted in subsequent example embodiments.

The reception unit 301 receives a search condition. A specific configuration of the reception unit 301 may be similar to that of the reception unit 110 in the first example embodiment. The output unit 303 outputs flow line information. A specific configuration of the output unit 303 may be similar to that of the output unit 120 in the first example embodiment.

The search unit 302 searches for a flow line, based on the search condition received by the reception unit 301. For example, the search unit 302 extracts a flow line that satisfies the search condition received by the reception unit 301 from a database in which the flow lines are recorded. This database may be included in the flow-line search system 300, but may not be included therein.

Specifically, the search unit 302 searches for a flow line according to an operation received by the reception unit 301 among flow lines of a plurality of objects recorded in a predetermined space. For example, the search unit 302 searches for a flow line including all positions designated by arrangement received by the reception unit 301.

The flow-line search system 300 is constituted by one or a plurality of devices. FIGS. 3B and 3C are block diagrams illustrating a configuration example when the flow-line search system 300 is constituted by a plurality of devices. The flow-line search system 300 may include a flow-line output device 310 and a flow-line search device 320 illustrated in FIG. 3B. Alternatively, the flow-line search system 300 may include a flow-line search device 330 and a flow-line output device 340 illustrated in FIG. 3C.

The flow-line output device 310 includes the reception unit 301 and the output unit 303. The flow-line output device 310 relates to one example of the flow-line output device 100 in the first example embodiment. The flow-line output device 310 is a terminal device such as a smartphone or a tablet, for example. On the other hand, the flow-line search device 320 includes the search unit 302. The flow-line search device 320 is, for example, a server device that can communicate with the flow-line output device 310.

The flow-line search device 330 includes the reception unit 301 and the search unit 302. On the other hand, the flow-line output device 340 includes the output unit 303. The flow-line search device 330 and the flow-line output device 340 are configured in such a way as to be able to communicate with each other, similarly to the flow-line output device 310 and the flow-line search device 320.

Note that the number of the flow-line output devices 310 or 340 and the number of the flow-line search devices 320 or 330 are not limited to a specific number. For example, the flow-line search system 300 may have a configuration in which a plurality of flow-line output devices 310 (or 340) are connected to one flow-line search device 320 (or 330).

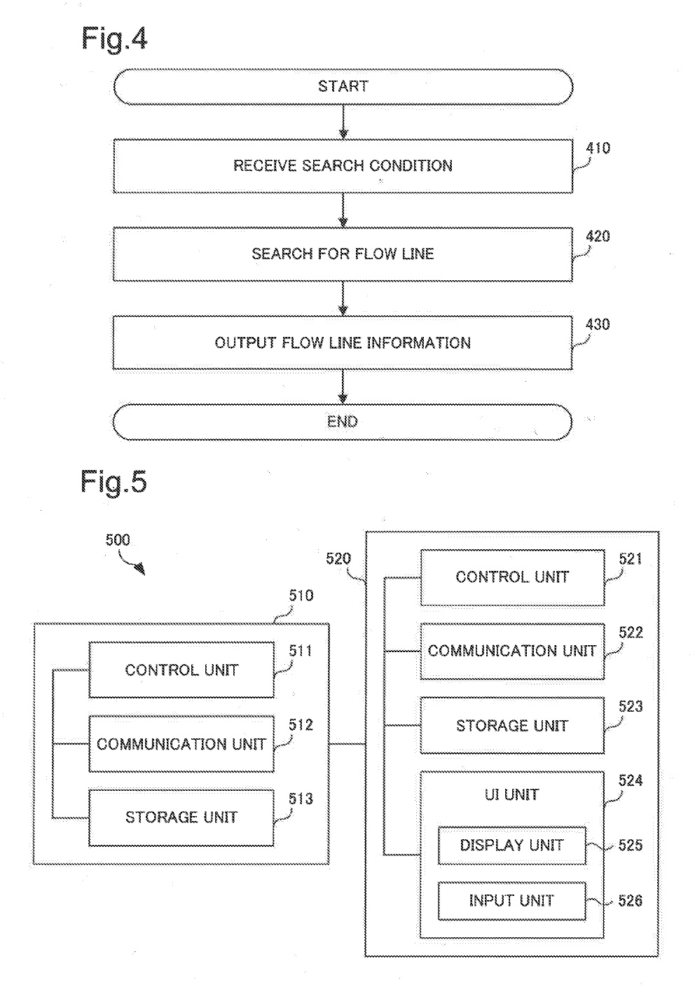

FIG. 4 is a flowchart illustrating a flow-line search method by the flow-line search system 300. In Step 410, the reception unit 301 receives a search condition. In Step 420, the search unit 302 searches for a flow line according to the search condition in Step 410. In Step 430, the output unit 303 outputs flow line information indicating the flow-line searched in Step 420.

As described above, the flow-line search system 300 in the present example embodiment has a configuration that receives a search condition that designates a plurality of positions, and outputs flow line information according to the received search condition. With this configuration, the flow-line search system 300 can achieve an action effect similar to that of the flow-line output device 100 in the first example embodiment. Further, the flow-line output devices 310 and 340 can reduce a component or a function thereof in comparison with a case where they include all components or functions of the flow-line search system 300.

### Third Example Embodiment

FIG. 5 is a block diagram illustrating a configuration of a flow-line search system 500 according to still another example embodiment. The flow-line search system 500 is a system for searching for a flow line of a person (customer or salesclerk) in a store. The flow-line search system 500 is configured in such a way as to include a server device 510 and a user terminal 520. The server device 510 and the user terminal 520 are configured in such a way as to be able to communicate with each other via a network such as a local area network (LAN).

The server device 510 relates to one example of the flow-line search device 320 in the second example embodiment. In other words, the server device 510 is a device for searching for a flow line. However, in the present example embodiment, it is assumed that an object of which a flow line is recorded, namely, a search target is a person. The server device 510 includes a control unit 511, a communication unit 512, and a storage unit 513.

The control unit 511 controls an operation of each unit in the server device 510. The control unit 511 includes a processing device (processor), such as a central processing unit (CPU), and a main storage device (memory), for example. The control unit 511 controls an operation of each unit in the server device 510 by executing a program. For example, the control unit 511 reads data from the storage unit 513, and transmits the read data to the user terminal 520 via the communication unit 512. Further, the control unit 511 may achieve a function relating to the search unit 302 in the second example embodiment.

The communication unit 512 exchanges data with the user terminal 520. For example, the communication unit 512 includes interface equipment (such as a network adapter) complying with a predetermined communication method. It is assumed that communication by the communication unit 512 is on a wireless LAN in the present example embodiment, but the present example embodiment is not limited to this.

The storage unit 513 stores data. The storage unit 513 includes a storage device such as a hard disk. The storage unit 513 may include a removable recording medium, and be configured so as to read necessary data from this recording medium or write necessary data to this recording medium. Data stored in the storage unit 513 include flow line data.

In the present example embodiment, flow line data are data indicating behavior of a person in a store for each person. The flow line data include at least data indicating a flow line of a person in a store. Further, the flow line data may additionally include attribute data associated with a person. The attribute data relates to one example of the additional information in the first example embodiment. Details of the flow line data are described later.

The user terminal 520 relates to one example of the flow-line output device 100 in the first example embodiment or the flow-line output device 310 in the second example embodiment. The user terminal 520 is a device for receiving an operation by a user (mainly, a person concerned with a store) and displaying information. The user terminal 520 includes a control unit 521, a communication unit 522, a storage unit 523, and a UI unit 524. Note that a plurality of the user terminals 520 may be included in the flow-line search system 500.

The control unit 521 controls an operation of each unit in the user terminal 520. The control unit 521 includes a processing device, such as a CPU, and a main storage device, for example. The control unit 521 controls an operation of each unit in the user terminal 520 by executing a program. For example, the control unit 521 controls data communication by the communication unit 522 and displaying of information by the UI unit 524.

The communication unit 522 exchanges data with the server device 510. For example, the communication unit 522 includes a wireless communication chip and an antenna complying with a communication method similar to that of the communication unit 512.

The storage unit 523 stores data. The storage unit 523 includes a recording medium, such as a flash memory, and a reader/writer of the recording medium. The storage unit 523 may be configured to include a removable recording medium, similarly to the storage unit 513. Data stored in the storage unit 523 include map data for illustrating a space in which a flow line is recorded.

The map data is data for displaying a component (such as a passage and a wall) of a space in which a flow line is recorded. An image displayed by using the map data is also generally referred to as a floor map, a floor plan, a sketch, a map, and the like. The map data in the present example embodiment indicate a floor map of a predetermined area in a store. For example, the map data display a passage in which a person can walk and the other portions (such as a product shelf and a wall) in such a way as to be recognizable. The floor map in the present example embodiment may be a part or the whole of the store.

The UI unit 524 includes a display unit 525 and an input unit 526, more specifically. The display unit 525 displays an image according to image data. The display unit 525 includes a display panel using a display element such as a liquid crystal and a drive circuit of the display panel. The input unit 526 receives an input (namely, an operation) relating to a search condition designated by a user. The UI unit 524 relates to one example of the reception unit 301 and the output unit 303 in the second example embodiment.

In the present example embodiment, the UI unit 524 includes a touch screen display. In other words, the UI unit 524 includes a display surface capable of displaying an image and also receiving an operation. However, the UI unit 524 may not necessarily include a touch screen display. Further, the UI unit 524 may include a button and a switch other than a touch screen display.

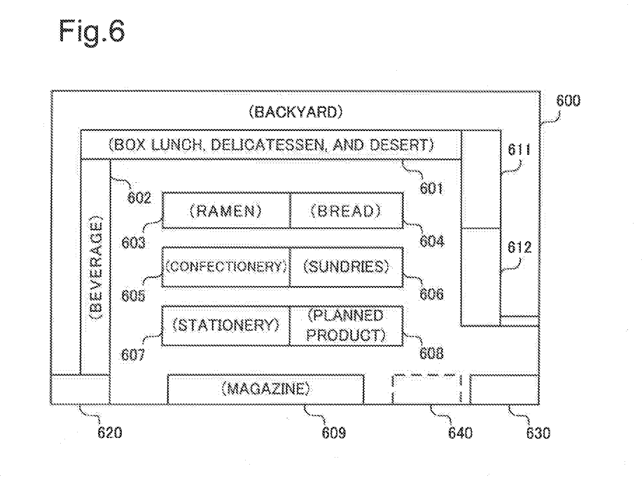

FIG. 6 is a diagram exemplifying a floor map displayed by using map data. In this example, a floor map 600 illustrates a sketch of a convenience store. The floor map 600 displays shelves 601 to 609, registers 611 and 612, a restroom 620, an information terminal 630, and an entrance 640. The information terminal herein is electronic equipment for providing a predetermined service, and includes a function such as, for example, an automatic teller machine (ATM), a copying machine, or the like.

The map data may simply be image data, and may include arrangement information indicating arrangement of components in a space in which a flow line is recorded. More specifically, the arrangement information represents information indicating arrangement (layout) of objects arranged in a store. In a case of the example of FIG. 6, the arrangement information indicates positions of the shelves 601 to 609, the registers 611 and 612, and the like. For example, coordinates of the shelves 601 to 609, the registers 611 and 612, and the like are described by a coordinate system with a predetermined position as an origin in the arrangement information. Note that a place where these objects are not arranged is a passage, namely, a place where a person can pass in the following description.

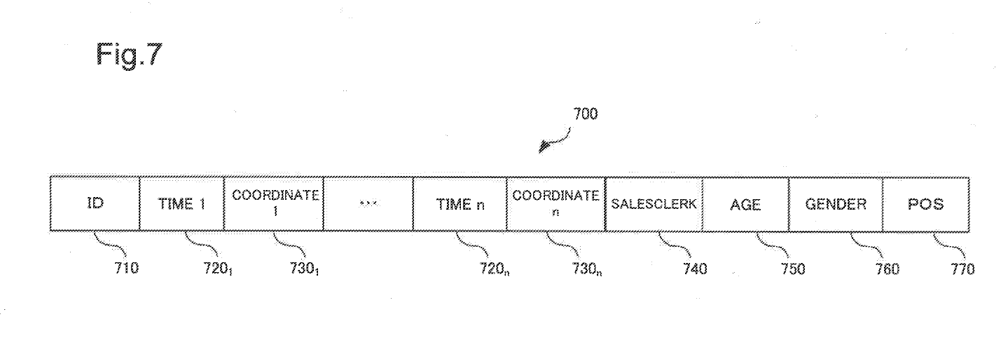

FIG. 7 is a diagram exemplifying a data structure of flow line data. In this example, flow line data 700 includes identification data 710, time data 720₁ to 720ₙ, coordinate data 730₁ to 730ₙ, a salesclerk flag 740, age data 750, gender data 760, and point of sale (POS) data 770. The time data 720₁ to 720ₙ and the coordinate data 730₁ to 730ₙ relates to one example of the flow line information in the first example embodiment. The salesclerk flag 740, the age data 750, the gender data 760, and the POS data 770 relate to one example of the attribute data.

The identification data 710 are information for identifying the flow line data 700. In other words, it can be said that the identification data 710 is information for identifying a person (person moving on a route indicated by the flow line data 700) related to the flow line data 700. The identification data 710 are, for example, an identifier (ID) that can uniquely specify the flow line data 700 and is not redundant.

The time data 720₁ to 720ₙ and the coordinate data 730₁ to 730ₙ are information indicating a position of a person having a flow line being recorded and a time at which the person is located in the position. The time data 720₁ to 720ₙ are data indicating a date and time in a predetermined format. The coordinate data 730₁ to 730ₙ are data indicating coordinates in a predetermined coordinate system (for example, a coordinate system common to arrangement information). The time data 720₁ to 720ₙ and the coordinate data 730₁ to 730ₙ may be recorded at predetermined time intervals (such as every one second and every five seconds), which may not necessarily be equal intervals.

For the time data 720₁ to 720ₙ and the coordinate data 730₁ to 730ₙ, the time data 720₁ and the coordinate data 730₁, for example, are associated with each other. In other words, coordinates indicated by the coordinate data 730₁ indicate a position of a person at a date and time indicated by the time data 720₁. Note that a value of n, namely, a total number of the time data and the coordinate data is not limited to a specific value, and may vary from flow line to flow line (namely, person to person).

A line connecting coordinates indicated by the coordinate data 730₁ to 730ₙ relates to a flow line. When coordinate data 730ᵢ are apart from coordinate data 730ᵢ₊₁, the control unit 511 interpolates a flow line between coordinates indicated by these pieces of coordinate data by an appropriate method (however, 1≤i≤n−1). The flow line indicated by the coordinate data 730₁ to 730ₙ may be expressed by a set of n−1 line segments that connect n coordinates, or may be expressed by a Bezier curve with n coordinates as anchor points.

The salesclerk flag 740 is data indicating whether a person related to the flow line data 700 is a salesclerk or a customer. The customer herein represents a visitor of a store, and it does not matter whether or not the customer actually purchases a product in the store. In the present example embodiment, it is assumed that a salesclerk and a customer are distinguishable by a known method.

The age data 750 are data indicating an age (or an age group) of a person related to the flow line data 700. The gender data 760 are data indicating a gender of a person related to the flow line data 700. The POS data 770 indicates, when a person related to the flow line data 700 has a purchase history in a store, the purchase history.

The attribute data may be recorded together with a flow line. For example, when a flow line is recorded based on an image captured by a camera, an age and a gender of a person can be estimated based on the image. Further, when a salesclerk is wearing a uniform or a specific belonging, that is, when a salesclerk is distinguishable by a feature in terms of appearance, whether or not a person is a salesclerk can be estimated based on an image. Alternatively, a flow line passing through an area (such as an employee's entrance and a backyard) through which only a salesclerk normally passes and a customer does not pass may be estimated as a flow line of a salesclerk.

Alternatively, the attribute data such as the age data 750, the gender data 760, and the POS data 770 may be recorded by a method different from that for recording a flow line, and associated with the flow line data 700. For example, when a loyalty program using a point card and the like is conducted in a store, information about an age, a gender, a purchase history, and the like of a customer can be acquired via this loyalty program.

Note that the flow line data is not limited to the structure exemplified in FIG. 7. For example, the flow line data may be recorded as different data for each coordinate indicated by the coordinate data 730₁ to 730ₙ or for each time indicated by the time data 720₁ to 720ₙ. A specific data structure of the flow line data does not matter as long as coordinates are recorded in the flow line data so as to be able to identify a flow line of a person.

The flow-line search system 500 has the configuration described above. In the present example embodiment, a user can search for a desired flow line among flow lines recorded as flow line data by operating the user terminal 520. Specifically, a user can search for a flow line by a touch operation using the UI unit 524.

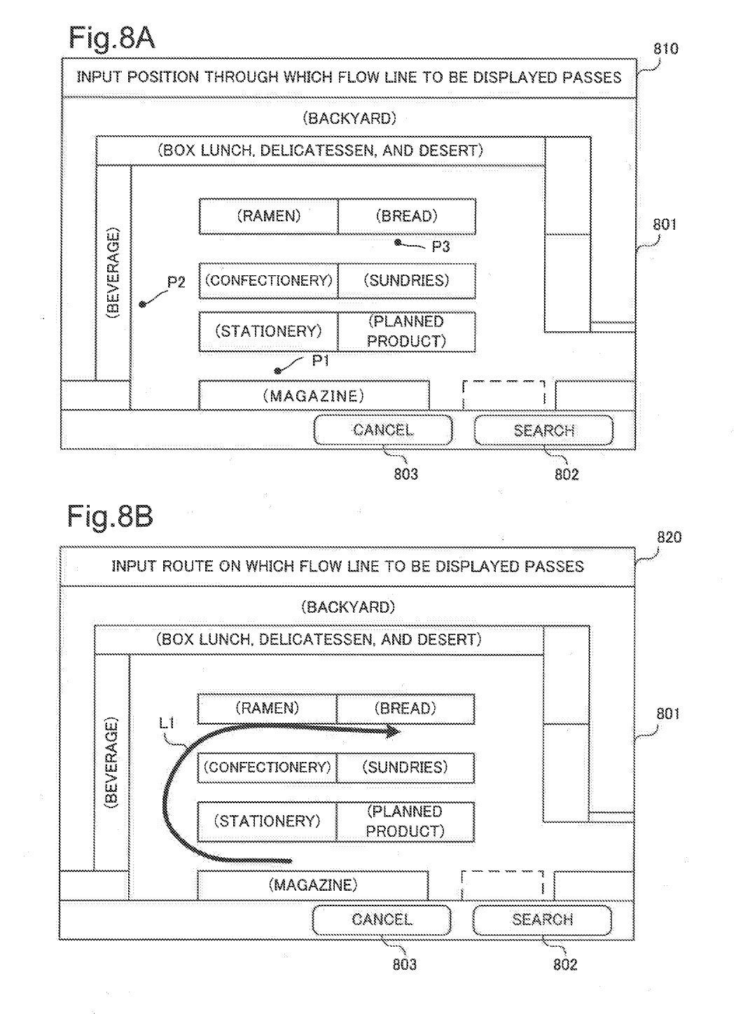

FIGS. 8A and 8B are diagrams exemplifying a screen displayed on the UI unit 524. FIG. 8A illustrates a screen 810 displayed when a flow line is searched by inputting a plurality of points. On the other hand, FIG. 8B illustrates a screen 820 displayed when a flow line is searched by inputting a line. In either case, a user can input a point or a line by touching the UI unit 524 with a pointer such as a finger and a stylus. The UI unit 524 supplies coordinate data indicating an input point or an input line according to an operation by a user to the control unit 521.

The screens 810 and 820 each include a floor map 801, a search button 802, and a cancel button 803. The floor map 801 is displayed based on the map data stored in the storage unit 523. The search button 802 is a button selected (touched) when an input is confirmed and a search is performed. The cancel button 803 is a button selected when an input is canceled.

In the screen 810, points P1, P2, and P3 are points input by a user. In this example, the user requests a search for a flow line of a person passing through the points P1, P2, and P3. Therefore, a search condition in this case is a “flow line of a person passing through the points P1, P2, and P3”. In other words, it can also be said that this search condition requests a search for a flow line of a person passing through the front of a product shelf of “magazine”, a product shelf of “beverage”, and a product shelf of “bread”. Note that it is assumed that the user inputs the point P1 first and inputs the point P3 lastly.

The number of points input by the user in the example of FIG. 8A is not particularly limited. In other words, the number of points input by the user may be two or less, or may be four or more. Note that, in this example, the user terminal 520 and the server device 510 do not prevent a search for a flow line by an input of only one point.

In the screen 820, a line L1 is a line input by a user. It can be said that the line L1 is also a plurality of continuous points. In this example, the user requests a search for a flow line closely resembling the line L1. Therefore, a search condition in this case is a “flow line closely resembling the line L1”. Note that it is assumed that the user inputs the line L1 in a direction of an arrow indicated by the line L1 (namely, clockwise).

A method of designating a search condition may be selectable. In other words, the UI unit 524 may receive an operation of a user by either method in FIG. 8A or 8B. Further, the UI unit 524 may be configured in such a way as to further receive a user operation of designating a method of designating a search condition. The control unit 521 generates a search query according to an operation by a user.

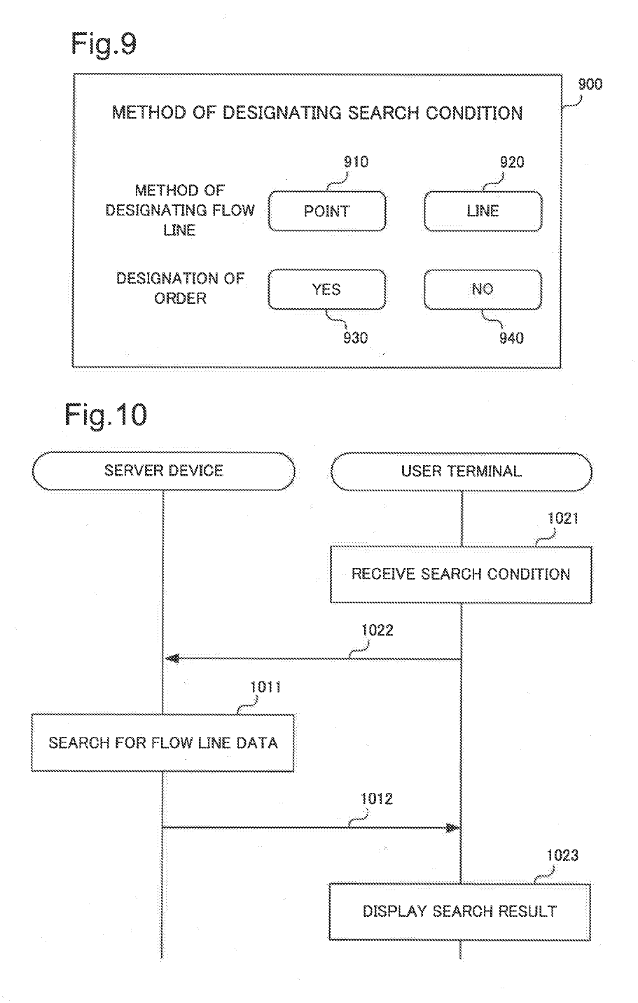

FIG. 9 is a diagram exemplifying a screen for selecting a method of designating a search condition. The UI unit 524 may display a widow 900 as pop up when displaying the screen 810 or 820. The window 900 includes buttons 910, 920, 930, and 940.

The buttons 910 and 920 are buttons for selecting whether a flow line is designated by a point (a plurality of points) or a line. When the button 910 is selected by a user, the UI unit 524 displays the screen 810. On the other hand, when the button 920 is selected by a user, the UI unit 524 displays the screen 820.

The buttons 930 and 940 are buttons for selecting whether to designate a flow line together with an order. When the button 930 is selected by a user, a flow line to be searched follows an order of operations designated by the user. On the other hand, when the button 940 is selected by a user, a flow line to be searched is not limited to an order of operations designated by the user.

For example, when the button 930 is selected in the example of FIG. 8A, the control unit 521 generates a search query that searches for a flow line passing through the points P1, P2, and P3 in this order. On the other hand, when the button 940 is selected in the example of FIG. 8A, the control unit 521 generates a search query that also contains, in addition to a flow line passing through the points P1, P2, and P3 in this order, flow lines passing through the points P1, P2, and P3 in an order different from the order above, for example, an order of the points P3, P2, and P1 or an order of the points P1, P3, and P2, in a search result.

Further, when the button 930 is selected in the example of FIG. 8B, the control unit 521 generates a search query that searches for a flow line in which a movement direction of a person is the same direction as that of the line L1 (namely, clockwise) among flow lines closely resembling the line L1. On the other hand, when the button 940 is selected in the example of FIG. 8B, the control unit 521 generates a search query that also contains, in addition to a flow line in which a movement direction of a person is the same direction as that of the line L1 among flow lines closely resembling the line L1, a flow line in an opposite direction to the line L1 (namely, counterclockwise) in a search result.

Note that the UI unit 524 may receive an operation of designating an attribute of a person having a flow line to be searched in addition to the buttons exemplified in FIG. 9. For example, the UI unit 524 may receive an operation of limiting a search for a flow line to either a customer or a salesclerk, and an operation of limiting an age or a gender of a person. Alternatively, the UI unit 524 may receive an operation of limiting a flow line to be searched to a flow line of a person who has purchased a specific product, and an operation of limiting a date and time at which a flow line is recorded.

FIG. 10 is a sequence chart illustrating a method of searching a flow line by the flow-line search system 500. In Step 1021, the user terminal 520 receives an operation by a user indicating a search condition.

Specifically, the user terminal 520 receives an operation by a user in the UI unit 524. The UI unit 524 supplies coordinate data according to an operation by a user to the control unit 521.

In Step 1022, the user terminal 520 transmits a search query to the server device 510. Herein, the control unit 521 generates a search query according to the coordinate data supplied from the UI unit 524. For example, the control unit 521 generates a search query including the coordinate data supplied from the UI unit 524 as a search condition. Further, the control unit 521 may generate a search query including an order related to each coordinate indicated by the coordinate data, an attribute of a person, or the like as a search condition. The control unit 521 transmits the search query generated in such a manner to the server device 510 via the communication unit 522.

In Step 1011, the server device 510 searches for flow line data, based on the search query transmitted from the user terminal 520. Herein, the control unit 511 extracts flow line data satisfying the search condition indicated by the search query from flow line data stored in the storage unit 513.

More specifically, the control unit 511 extracts, based on the coordinate data included in the search query, a flow line of a person estimated that the person has passed through a position indicated by the coordinate data. Alternatively, the control unit 511 extracts a flow line of a person estimated that the person has passed through a position indicated by the coordinate data or a vicinity of the position. The vicinity herein represents, for example, a predetermined range with reference to the position indicated by the coordinate data.

As exemplified in FIG. 8B, when a line is input by a user, the control unit 511 extracts a flow line closely resembling the line indicated by the input. For example, the control unit 511 calculates a ratio or a numerical value (hereinafter also referred to as “similarity”) indicating a degree that the line indicated by the input of the user is similar to a flow line indicated by the flow line data, and extracts a flow line (namely, a similar flow line) of which similarity is greater than or equal to a predetermined threshold value. Alternatively, the control unit 511 may calculate a distance between each coordinate of a flow line indicated by the flow line data and the line indicated by the input of the user, and extract a flow line whose distances from coordinates are respectively less than or equal to a predetermined threshold value. These threshold values may be able to be set by a user.

Further, when a search condition other than the coordinate data is included in the search query, the control unit 511 extracts flow line data satisfying the search condition. For example, when an age or a gender of a person is included in the search condition, the control unit 511 extracts flow line data about a person having a specific age or a specific gender. In other words, in this case, the control unit 511 narrows down a search result compared with a case where a search condition other than the coordinate data is not included.

In Step 1012, the server device 510 transmits the flow line data extracted in Step 1011 to the user terminal 520. Specifically, the control unit 511 transmits the flow line data to the user terminal 520 by supplying the flow line data extracted in Step 1011 to the communication unit 512, and thus.

In Step 1012, the control unit 511 may transmit a part instead of the whole of the flow line data to the user terminal 520. For example, the control unit 511 may transmit, to the user terminal 520, data obtained by excluding data (such as attribute data), which is not necessary for displaying a flow line, from the flow line data. The control unit 511 transmits at least the coordinate data among the flow line data to the user terminal 520.

In Step 1023, the user terminal 520 displays a search result, based on the flow line data transmitted from the server device 510. For example, the control unit 521 generates image data that display a flow line indicated by the flow line data transmitted from the server device 510 superimposed on a floor map, and supplies the image data to the UI unit 524. Further, in addition to the flow line indicated by the flow line data, the control unit 521 may display other information related to the flow line on the UI unit 524.

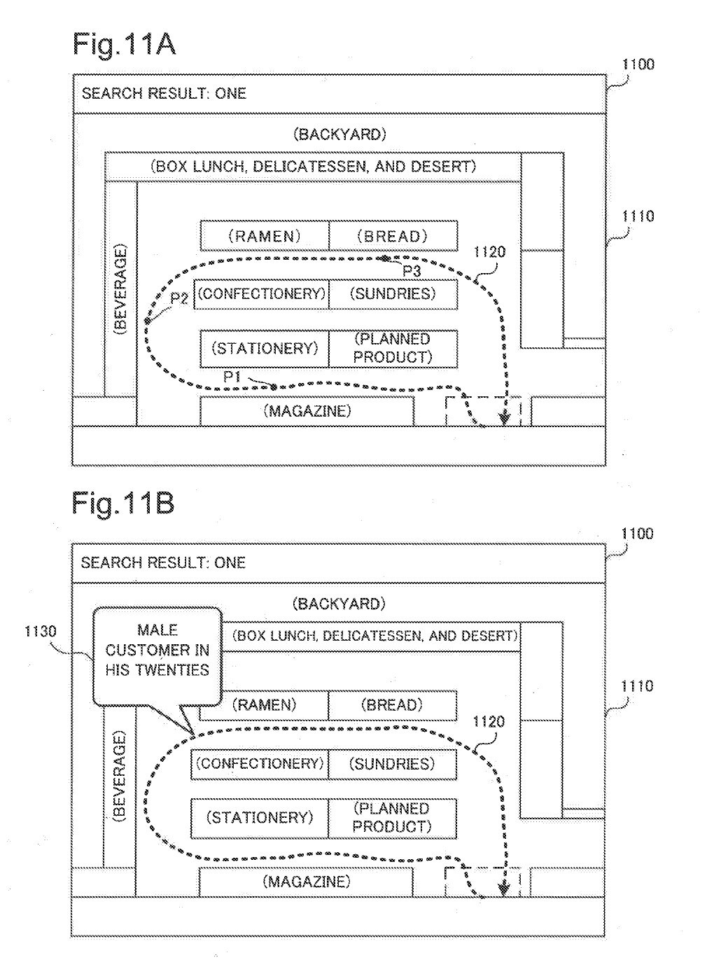

FIGS. 11A and 11B are diagrams exemplifying a screen for displaying a search result of a flow line. A screen 1100 includes a flow line 1120 relating to a search result in addition to a floor map 1110 similar to that in FIG. 8A. The screen 1100 may further include a search condition (points P1, P2, and P3 in FIG. 11A) designated by a user. Note that a flow line relating to a search result is one herein for the sake of description, but a plurality of flow lines may be included.

The screen 1100 illustrated in FIG. 11B further includes additional information 1130. The additional information 1130 is information displayed based on the flow line data transmitted from the server device 510. For example, the additional information 1130 is displayed by using a part or the whole of attribute data. The additional information 1130 in FIG. 11B is an example of a case where a person related to the flow line 1120 is a “male” “customer” “in his twenties”.

The UI unit 524 may display the additional information 1130 upon a predetermined operation. For example, the UI unit 524 may display the additional information 1130 when a user performs an operation such as double taps or a long press on the flow line 1120. Further, the UI unit 524 may display the additional information 1130 on a screen different from that displays the flow line 1120. Alternatively, the UI unit 524 may display the additional information 1130 from a time of displaying the screen 1100 regardless of such an operation.

As described above, the flow-line search system 500 in the present example embodiment has a configuration that receives a search condition that designates a route or a plurality of positions, and displays a search result according to the received search condition. With this configuration, the flow-line search system 500 can achieve an action effect similar to that of the flow-line output device 100 in the first example embodiment.

Further, according to the flow-line search system 500, a user can designate a search condition for a flow line by an intuitive operation so as to touch a floor map. In this way, the user can relatively easily designate a search condition obtained by combining a plurality of specific positions (such as selling areas). Further, the user can also narrow down a search condition, based on attribute data and the like.

From a viewpoint of marketing, a search condition that combines a plurality of positions is more likely to get useful information than a search condition that does not. For example, product sales may fluctuate depending on arrangement of the products in a store. Further, it is known that, among products, there is a product being more likely to be purchased together with a certain product. The flow-line search system 500 can provide information contributing to an analysis of purchase tendency of a customer and the like to a user by selectively extracting a flow line via a specific selling area and a flow line on a specific route among many flow lines.

The flow-line search system 500 further has a configuration that associates a flow line of a customer with POS data. With this configuration, a user can grasp what kind of a product a customer following a certain route has purchased (or has not purchased). For example, by using a search result in the present example embodiment, a user can also analyze the number and proportion of customers who have purchased a product on sale in a plurality of specific selling areas and customers who have not purchased the product among customers who have passed through the selling areas.

### MODIFICATION EXAMPLE

For example, the following modification examples are applicable to the first to third example embodiments described above. These modification examples can be appropriately combined as necessary.

### Modification Example 1

The control unit 521 may replace or expand a position designated by a user. The replacement herein represents replacement of a position designated by a user with a different position. Further, the expansion herein represents replacement of a position designated by a user with a wider range. Hereinafter, such replacement is also collectively referred to as “correction”.

For example, when a user designates a position (on a product shelf, on a wall, and the like) in which a flow line cannot be located, the control unit 521 performs correction so as to replace the position with a position (on a passage and the like) in which a flow line can be located. Further, for example, when a user designates a specific position in a vicinity of a certain product shelf, the control unit 521 performs correction so as to expand the position to a specific range in the vicinity of the product shelf. The control unit 521 may perform such correction by referring to arrangement information.

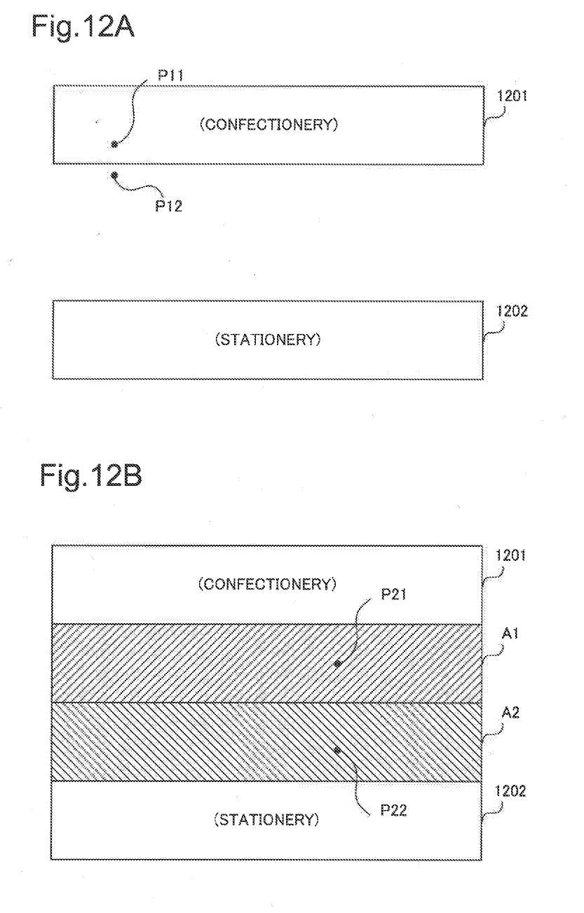

FIGS. 12A and 12B are diagrams illustrating one example of correction of a position by the control unit 521. FIGS. 12A and 12B illustrate a part of the floor map 600 (see FIG. 6). In these examples, it is assumed that product shelves 1201 and 1202 are arranged to face each other on the floor map. It is assumed that a passage is located between the product shelf 1201 and the product shelf 1202.

In the example of FIG. 12A, when a user designates a point P11, there is no flow line passing through this position. This is because the point P11 is a part of the product shelf 1201 and relates to a position through which a person cannot normally pass. In this case, the control unit 521 corrects the point P11 so as to be a relating point in a passage in a vicinity of the point P11, for example, a point P12. This can make it easy for a user to acquire a desired search result.

In the example of FIG. 12B, when a user designates a point P21, the control unit 521 expands the point P21 to a region A1 indicated by hatching. Further, when a user designates a point P22, the control unit 521 expands the point P22 to a region A2 indicated by hatching different from the region A1. The region A1 is a region closer to the product shelf 1201 when a space between the product shelf 1201 and the product shelf 1202 is divided into two. The region A2 is a region closer to the product shelf 1202 when a space between the product shelf 1201 and the product shelf 1202 is divided into two.

For example, it can be said that a user designating the point P21 intends to request a search for a flow line passing through a vicinity of the product shelf 1201. Similarly, it can be said that a user designating the point P22 intends to request a search for a flow line passing through a vicinity of the product shelf 1202. On the other hand, a person passing through the vicinity of the product shelf 1201 does not necessarily pass through the point P21. Therefore, replacing an input designated as a “point” with a “region (in a range wider than a point)” is effective in order to further reflect an intention of the user in a search result.

However, when an input of a user is expanded without limitation, a search result is contrarily less likely to reflect an intention of the user. For example, although a user requests a search for a flow line passing through the vicinity of the product shelf 1201, a flow line passing through the vicinity of the product shelf 1202 instead of passing through the vicinity of the product shelf 1201 is included in a search result, the search result is not expected by the user. Thus, the control unit 521 limits an expansion range of a point designated by a user to a certain range. More specifically, in this case, the control unit 521 determines an expansion range of an input by a user, based on arrangement of the product shelf 1201 and the product shelf 1202, namely, coordinates thereof.

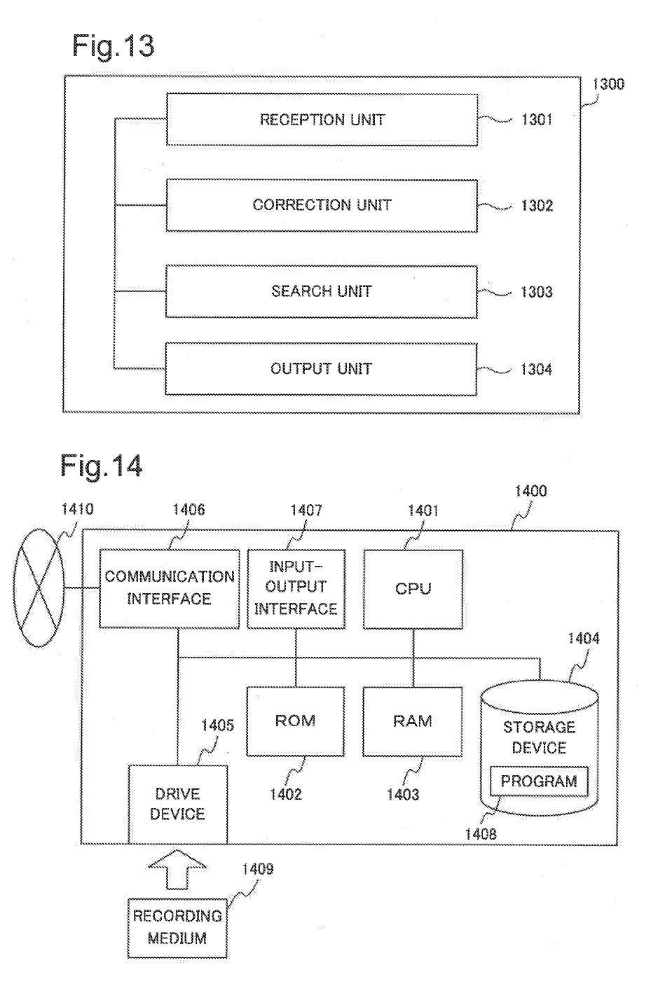

FIG. 13 is a block diagram illustrating a configuration example of a flow-line output device 1300 according to this modification example. The flow-line output device 1300 is configured in such a way as to include a reception unit 1301, a correction unit 1302, a search unit 1303, and an output unit 1304. Compared to the flow-line search system 300 (see FIG. 3A) in the second example embodiment, the flow-line output device 1300 is different from in that it includes the correction unit 1302.

The reception unit 1301 receives a search condition. The correction unit 1302 corrects the search condition received by the reception unit 1301. The search unit 1303 searches for a flow line, based on the search condition that is received by the reception unit 1301 and is corrected by the correction unit 1302. The output unit 1304 outputs flow line information indicating the flow line searched by the search unit 1303.

Note that the correction unit 1302 may be included in either of the server device 510 or the user terminal 520. However, when the correction unit 1302 is included in the server device 510, the server device 510 stores arrangement information in the storage unit 513, or receives arrangement information from the user terminal 520. Then, the control unit 511 corrects a search condition included in a search query, based on the arrangement information.

### Modification Example 2

In general, when a customer picks up a product displayed on a product shelf, or shows an interest in the product, a movement speed of the customer tends to decrease. Further, even when a customer passes through the front of a product shelf, it is highly likely that the customer is not showing any interest in a product displayed on the product shelf in a case where a movement speed of the customer is fast. In this way, actual behavior of a customer passing through a vicinity of a product shelf may be able to be classified to some extent according to a movement speed of the customer.

Thus, when a flow line is searched, the control unit 511 may extract a flow line in which a movement speed in a position designated by a user or in a vicinity of the position is less than or equal to a predetermined threshold value among flow lines passing though the position or the vicinity of the position. This threshold value may vary from flow line to flow line so as to be determined based on an average value of a movement speed from a starting point to an end point of a flow line, for example. In this way, a flow line of a person merely passing through a position designated by a user or a vicinity of the position can be excluded from a search result.

### Modification Example 3

The control unit 521 may further narrow down a flow line after a search result is displayed. For example, when the UI unit 524 receives an operation of changing a method of designating a search condition after a search result is displayed once, the control unit 521 transmits a search query according to a changed designation method to the server device 510. For example, a user can narrow down a search result by increasing a point designated on a floor map. Further, the user can narrow down a search result by designating an order of points (see FIG. 9) further than a case where an order of points is not designated. Alternatively, the user can also narrow down a search result by switching a method of designating a flow line (see FIG. 9) from a point to a line.

### Modification Example 4

The third example embodiment described above can also be used for an object other than a person. In other words, an object having a flow line being recorded is not limited to a person. An object having a flow line being recorded may be, for example, equipment (such as a cart) moved by manipulation by a person.

Further, the server device 510 may be configured in such a way as to extract a flow line of an object of a specific kind. For example, when a flow line of a person and a flow line of an object other than a person are recorded together, the server device 510 can extract only a flow line of a person. In this case, flow line information includes a kind of an object (whether a person or not) as attribute data.

### Modification Example 5

Flow line data may express coordinates of a search target two-dimensionally, and may also express coordinates of a search target three-dimensionally. In other words, flow line data may include information indicating a height of a search target. Further, a space in which a flow line is recorded may include a multi-floors structure. For example, a space in which a flow line is recorded may be a building having a plurality of floors.

When a flow line is recorded on a plurality of floors, the flow-line search system 500 may be configured in such a way as to be able to search for a flow line of a person passing through a predetermined position on a certain floor and a predetermined position on a another floor. For example, the flow-line search system 500 may be configured in such a way as to be able to search for a flow line of a person passing through a certain selling area on a first floor and another selling area on a third floor among flow lines recorded in a department store. In a case where information indicating a height of a search target is included in the flow line data, such a search can be performed. In this case, map data are also configured to include a floor map of each floor.

### Modification Example 6

A specific hardware configuration of a device according to the present disclosure has diverse variations, and is not limited to a specific configuration. For example, the device according to the present disclosure may be achieved by using software or configured in such a way as to share various processing by using a plurality of hardware.

FIG. 14 is a block diagram illustrating one example of a hardware configuration of a computer device 1400 that achieves the device according to the present disclosure. The computer device 1400 is configured in such a way as to include a central processing unit (CPU) 1401, a read only memory (ROM) 1402, a random access memory (RAM) 1403, a storage device 1404, a drive device 1405, a communication interface 1406, and an input-output interface 1407. The device according to the present disclosure may be achieved by the configuration (or a part thereof) illustrated in FIG. 14.

The CPU 1401 executes a program 1408 by using the RAM 1403. The program 1408 may be stored in the ROM 1402. Further, the program 1408 may be recorded in a recording medium 1409 such as a memory card and read by the drive device 1405, or may be transmitted from an external device via a network 1410. The communication interface 1406 exchanges data with an external device via the network 1410. The input-output interface 1407 exchanges data with a peripheral device (such as an input device and a display device). The communication interface 1406 and the input-output interface 1407 may function as a component for acquiring or outputting data.

Note that a component of the device according to the present disclosure may be formed of a single circuit (such as a processor) or a combination of a plurality of circuits. The circuit (circuitry) herein may be either a dedicated or general-purpose circuit. For example, a part of the device according to the present disclosure may be achieved by a dedicated processor, and the other part thereof may be achieved by a general-purpose processor.

The configuration described as a single device in the above-described example embodiments may be distributed in a plurality of devices. For example, the flow-line output device 100 may be achieved by cooperation of a plurality of computer devices by using a cloud computing technology and the like.

As described above, the present invention is described by taking the example embodiments and the modification examples described above as model examples. However, the present invention is not limited to these example embodiments and modification examples. The present invention may include an example embodiment to which various modifications or applications that may be understood by a so-called person skilled in the art are applied within a scope of the present invention. Further, the present invention may include an example embodiment in which matters described in the description are appropriately combined or replaced as necessary. For example, a matter described with a specific example embodiment may also be applied to another example embodiment within an extent that there is no inconsistency.

[Supplementary Note]

The whole or part of the exemplary embodiments disclosed above can be described as, but not limited to, the following supplementary notes.

(Supplementary Note 1)

A flow-line output device includes:

reception means for receiving a condition indicating a route or a plurality of positions; and

output means for outputting information indicating a flow line according to the received condition among flow lines of a plurality of targets.

(Supplementary Note 2)

The flow-line output device according to supplementary note 1, wherein

the condition indicates the route and a direction of the route, and

the output means outputs the information indicating one or a plurality of flow lines of the targets moving on the route or a vicinity of the route in a direction indicated by the condition.

(Supplementary Note 3)

The flow-line output device according to supplementary note 1, wherein

the condition indicates the plurality of positions and an order of designation of the plurality of positions, and

the output means outputs the information indicating one or a plurality of flow lines of the targets moving to the plurality of positions or in a vicinity of the plurality of positions in the order indicated by the condition.

(Supplementary Note 4)

The flow-line output device according to any one of supplementary notes 1 to 3, wherein

the output means outputs the information indicating the flow line and additional information associated with the information.

(Supplementary Note 5)

The flow-line output device according to any one of supplementary notes 1 to 4, wherein

a method of designating the condition can be selectable by a user.

(Supplementary Note 6)

The flow-line output device according to supplementary note 5, wherein

the condition is changeable after the information is output by the output means, and

the output means outputs information indicating a flow line according to the changed condition.

(Supplementary Note 7)

The flow-line output device according to any one of supplementary notes 1 to 6, further includes:

correction means for correcting the condition received by the reception means, based on arrangement information indicating arrangement of a component in a space in which the plurality of targets move.

(Supplementary Note 8)

The flow-line output device according to any one of supplementary notes 1 to 7, wherein

the output means outputs the information by using arrangement information indicating arrangement of a component in a space in which the plurality of targets move.

(Supplementary Note 9) A flow-line output method includes:

receiving a condition indicating a route or a plurality of positions; and

outputting information indicating a flow line according to the received condition among flow lines of a plurality of targets.

(Supplementary Note 10)

The flow-line output method according to supplementary note 9, wherein

the condition indicates the route and a direction of the route, and

the outputting includes outputting the information indicating one or a plurality of flow lines of the targets moving on the route or a vicinity of the route in a direction indicated by the condition.

(Supplementary Note 11)

A flow-line output method includes:

illustrating a certain space;

receiving a condition indicating a route or a plurality of positions in the illustrated space; and

displaying a flow line according to the received condition among flow lines of a plurality of targets recorded in the space.

(Supplementary Note 12)

A flow-line search method includes:

illustrating a certain space;

receiving a condition indicating a route or a plurality of positions in the illustrated space;

searching for a flow line according to the received condition among flow lines of a plurality of targets recorded in the space; and

displaying the searched flow line.

(Supplementary Note 13)

A non-temporary computer-readable recording medium recording a program causing a computer to execute:

a process of receiving a condition indicating a route or a plurality of positions; and

a process of outputting information indicating a flow line according to the received condition among flow lines of a plurality of targets.

(Supplementary Note 14)

The recording medium according to supplementary note 13, wherein

the condition indicates the route and a direction of the route, and the processing of outputting outputs the information indicating one or a plurality of flow lines of the targets moving on the route or a vicinity of the route in a direction indicated by the condition.

(Supplementary Note 15)

A flow-line search system includes:

reception means for receiving a condition indicating a route or a plurality of positions;

search means for searching for a flow line according to the received condition among flow lines of a plurality of targets; and output means for outputting information indicating the searched flow line.

(Supplementary Note 16)

The flow-line search system according to supplementary note 15, wherein

the condition indicates the route and a direction of the route, and the output means outputs the information indicating one or a plurality of flow lines of the targets moving on the route or a vicinity of the route in a direction indicated by the condition.

This application is based upon and claims the benefit of priority from Japanese patent application No. 2016-213284, filed on Oct. 31, 2016, the disclosure of which is incorporated herein in its entirety by reference.

### REFERENCE SIGNS LIST

100, 1300 Flow-line output device
110 Reception unit
120 Output unit
300, 500 Flow-line search system
510 Server device
520 User terminal
1400 Computer device

1. A flow-line output device comprising:
a memory; and
at least one processor coupled to the memory,
the processor performing operations, the operations comprising:
receiving a condition indicating a route or a plurality of positions; and
outputting information indicating a flow line according to the received condition among flow lines of a plurality of targets.

2. The flow-line output device according to claim 1, wherein
the condition indicates the route and a direction of the route, and
wherein the operations further comprises
outputting the information indicating one or a plurality of flow lines of the targets moving on the route or a vicinity of the route in a direction indicated by the condition.

3. The flow-line output device according to claim 1, wherein
the condition indicates the plurality of positions and an order of designation of the plurality of positions, and
wherein the operations further comprises
outputting the information indicating one or a plurality of flow lines of the targets moving to the plurality of positions or in a vicinity of the plurality of positions in the order indicated by the condition.

4. The flow-line output device according to claim 1, wherein
the operations further comprises
outputting the information indicating the flow line and additional information associated with the information.

5. The flow-line output device according to claim 1, wherein
a method of designating the condition can be selectable by a user.

6. The flow-line output device according to claim 5, wherein
the condition is changeable after the information is output,
wherein the operations further comprises
outputting information indicating a flow line according to the changed condition.

7. The flow-line output device according to claim 1,
wherein the operations further comprises
correcting the condition received, based on arrangement information indicating arrangement of a component in a space in which the plurality of targets move.

8. The flow-line output device according to claim 1, wherein the operations further comprises
outputting the information by using arrangement information indicating arrangement of a component in a space in which the plurality of targets move.

9. A flow-line output method comprising:
receiving a condition indicating a route or a plurality of positions; and
outputting information indicating a flow line according to the received condition among flow lines of a plurality of targets.

10. The flow-line output method according to claim 9, wherein
the condition indicates the route and a direction of the route, and
wherein the flow-line output method further comprises
outputting the information indicating one or a plurality of flow lines of the targets moving on the route or a vicinity of the route in a direction indicated by the condition.

11-12. (canceled)

13. A non-temporary computer-readable recording medium embodying a program, the program causing a computer to perform a method, the method comprising:
receiving a condition indicating a route or a plurality of positions; and
outputting information indicating a flow line according to the received condition among flow lines of a plurality of targets.

14. The recording medium according to claim 13, wherein
the condition indicates the route and a direction of the route, and
wherein the method further comprises
outputting outputs the information indicating one or a plurality of flow lines of the targets moving on the route or a vicinity of the route in a direction indicated by the condition.

15-16. (canceled)
